(19) United States
(12) Patent Application Publication
(10) Pub. No.: US 2019/0065462 A1
(43) Pub. Date: Feb. 28, 2019

(54) AUTOMATED MEDICAL REPORT FORMATTING SYSTEM

(71) Applicant: EMR.AI Inc., San Francisco, CA (US)

(72) Inventors: Wael Salloum, San Leandro, CA (US); Greg Finley, St. Paul, MN (US); Erik Edwards, Oakland, CA (US); Mark Miller, London (GB); David Suendermann-Oeft, San Francisco, CA (US)

(21) Appl. No.: 16/120,027

(22) Filed: Aug. 31, 2018

Related U.S. Application Data
(60) Provisional application No. 62/552,860, filed on Aug. 31, 2017.

(51) Int. Cl. G06F 17/27; G10L 15/26

(52) U.S. Cl. CPC G06F 17/2715; G06F 17/211; G10L 15/26

(57) ABSTRACT

Systems, methods, and computer-readable non-transitory storage medium in which a statistical machine translation model for formatting medical reports is trained in a learning phase using bitexts and in a tuning phase using manually transcribed dictations. Bitexts are generated from automated speech recognition dictations and corresponding formatted reports, using a series of steps including identifying matches and edits between the dictations and their corresponding reports using dynamic programming, merging matches with adjacent edits, calculating a confidence score, identifying acceptable matches, edits, and merged edits, grouping adjacent acceptable matches, edits, and merged edits, and generating a plurality of bitexts each having a predetermined maximum word count (e.g., 100 words), preferably with a predetermined overlap (e.g., two thirds) with another bitext. During the tuning phase, the system is trained by iteratively translating manually transcribed dictations and adjusting the relative model weights until best performance on error rate criteria (e.g., WER and CDER).

### CROSS-REFERENCE TO RELATED APPLICATION

This application claims priority from U.S. Provisional Patent Application Ser. No. 62/552,860, titled “Patent sketch: Machine translation postprocessor” (Attorney Docket No. 103123.0004PRO1), filed on Aug. 31, 2017. This and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF INVENTION

The field of the invention is automatic formatting medical reports, and more specifically, generating training data for training a statistical machine translation system.

### BACKGROUND

The following description includes information that can be useful in understanding the present disclosure. It is not an admission that any of the information provided herein is prior art or relevant to the presently claimed invention, or that any publication specifically or implicitly referenced is prior art.

Medical dictation is helpful in documenting clinical encounters. The dictated material can be transformed into a textual representation to be printed as a clinical letter or inserted into electronic medical record (EMR) systems. Automated speech recognition (ASR) can transform spoken words into plain text. Since ASR output is transcribed verbatim from speech, it contains command words, petitions, and grammatical errors, etc., and the text is typically case insensitive and contains only alphabetic characters without necessary punctuations. Therefore, post-processing is required to transform ASR output into clinical letters that follow rigorous formatting standards. Major responsibilities of post-processing include: truecasing, punctuation restoration, carrying out dictated commands (e.g., ‘new paragraph’, ‘scratch that’), converting numerical and temporal expressions, formatting acronyms and abbreviations, numbering itemized lists, separating sections and section headers, and inserting physician “normals” (sections of boilerplate text or templates).

Conventional post-processing approaches are predominantly rule-based. For example, U.S. Pat. No. 7,996,223 to Frankel teaches a post-processing system configured to implement rewrite rules by formatting raw speech recognition output into formatted documents and reports. These rule-based approaches are subject to serious disadvantages in practical use. For one, the task may become overly complex over time through the introduction of specific rules for certain hospitals or physicians. Another problem is that these systems must follow an ASR stage, where unforeseen errors may interfere destructively with post-processing, for which rules or models are typically designed or trained for idealized transcriptions.

PCT Patent Publication No. WO2017130089A1 by Hasan et al (hereinafter “Hasan”) teaches a paraphrase generation system using data-based machine modeling to convert complex clinical jargon into easier alternative paraphrases. However, Hasan does not address formatting. U.S. Pat. No. 7,813,929 to Bisani (hereinafter “Bisani”) teaches using a probabilistic word substitution model to generate an output structured sequence that has the highest probability from an unstructured speech recognition text. Although Bisani's system is trained with archived dictations and corresponding text documents that are cleaned (e.g., removing page headers and footers), tagged (e.g., identification of section headings), and tokenized, the training data used in Bisani still included major unpredictable edits between dictation and document (e.g., subjective stylistic edits, sections being reordered, insertion of metadata, patient history, templates, or other information not present in the dictation). It is impossible for an automated system to learn those unpredictable edits in Bisani. Moreover, Bisani's system suffers from low accuracy because it is not fine-tuned after it is trained with training data with unpredictable edits.

Thus, there is still a need for systems, devices, and methods to generate high-quality training data efficiently and to fine-tune a statistical machine translation (SMT) system, so that the SMT system can generate clinical reports accurately.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

### SUMMARY OF INVENTION

The inventive subject matter described herein provides computer-enabled apparatus, systems and methods in which a statistical machine translation system for formatting medical reports is 1) trained using bitexts generated from automated speech recognition dictations and corresponding formatted reports and 2) tuned with manually transcribed dictations.

Bitexts are parallel training data such that a single bitext is a string of words from the dictation and the corresponding string of words from the report. A preferred method of generating bitexts includes: preprocessing automated speech recognition dictations; comparing the dictations with the corresponding formatted reports to identify matches and edits between each dictation and its corresponding report using dynamic programming; merging matches with adjacent edits to produce merged edits; calculating a confidence score for each match, edit, and merged edit; identifying acceptable matches, edits, and merged edits that have an overall confidence score that is higher than a predetermined threshold; grouping adjacent acceptable matches, edits, and merged edits into a single piece of bitext having a predetermined maximum word count (e.g., 100 words); and generating bitexts comprising the grouped and ungrouped matches and edits that are acceptable.

In preferred embodiments, calculating confidence score can be achieved by calculating a statistical confidence score and a heuristic confidence score for each match, edit, and merged edit, and then calculating a weighted average confidence score of the statistical confidence score and the heuristic confidence score for each match, edit, and merged edit. In especially preferred embodiments, the statistical confidence score is given more weight than the heuristic confidence score. For example, the statistical confidence score is given 90% weight and the heuristic confidence score is given 10% weight. Also in preferred embodiments, the dynamic program considers two words to be a match if the confidence score (i.e., the probability of a target word replacing a source word) is at least 0.8.

It is contemplated that edits include substitutions, inserts and deletes. Preferably, acceptable substitutions have a minimal confidence score of 0.1, acceptable inserts and deletes have a minimal confidence score of 0.37, and all matches pass confidence checks. Contemplated method of merging of adjacent matches and edits involves using a heuristic algorithm. Contemplated method of grouping of adjacent acceptable matches, edits, and merged edits involves using an iterative algorithm.

Training the statistical machine translation system can be achieved by two phases. During the learning phase, the SMT system is trained using bitexts. During the tuning phase, SMT system is trained using manually transcribed dictations to balance a relative contribution. In preferred embodiments, the SMT system includes a phrase replacement model, a phrase reordering model, and a monolingual target language model. In the learning phase, the phrase replacement model and the phrase reordering model are trained using bitexts, and the monolingual target language model is trained using formatted reports. In the tuning phase, the SMT system is trained using manually transcribed dictations to balance the relative contributions of the phrase replacement model, the phrase reordering model, and the monolingual target language model.

It is contemplated that the SMT system is trained using an expectation maximization technique. In the tuning phase, training is performed by iteratively translating the plurality of manually transcribed dictations and adjusting the relative model weights until achieving best performance on objective error metrics, for example, word error rate (WER) and CDER. It is further contemplated that the SMT system is at least 10% more accurate after the tuning phase than before.

The inventive subject matter also includes a machine translation postprocessor (MTPP) for formatting texts from medical dictations using the SMT system trained as described herein. The system includes a processor configured to execute software instructions, stored on a non-transitory computer-readable medium, configured to receive texts transcribed from words spoken by a medical professional and formatting the texts using the SMT system trained as described herein. It is contemplated that the automated system can perform formatting texts in real time or near real time.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a flowchart depicting contemplated steps in preferred methods of generating bitexts for training a statistical machine translation (SMT) system.

FIG. 2 is a flowchart depicting contemplated steps in preferred methods of training a SMT system.

FIG. 3 is a schematic of an embodiment of a machine translation postprocessor (MTPP) using MT to perform translation.

FIG. 4a is an example of an automated speech recognition dictation, produced by an ASR.

FIG. 4b is a formatted report generated from the automated speech recognition dictation of FIG. 4a.

FIG. 5 is an overall schematic of preferred methods of generating bitexts and preferred methods for training the SMT system using the bitexts.

FIG. 6 is a schematic of a preferred method of using the SMT system in FIG. 5 to produce a formatted report.

### DETAILED DESCRIPTION

Throughout the following discussion, numerous references will be made regarding servers, services, interfaces, engines, modules, clients, peers, portals, platforms, or other systems formed from computing devices. It should be appreciated that the use of such terms is deemed to represent one or more computing devices having at least one processor (e.g., ASIC, FPGA, DSP, x86, ARM, ColdFire, GPU, multi-core processors, etc.) configured to execute software instructions stored on a computer readable tangible, non-transitory medium (e.g., hard drive, solid state drive, RAM, flash, ROM, etc). For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable media storing the instructions that cause a processor to execute the disclosed steps. The various servers, systems, databases, or interfaces can exchange data using standardized protocols or algorithms, possibly based on HTTP, HTTPS, AES, public-private key exchanges, web service APIs, known financial transaction protocols, or other electronic information exchanging methods. Data exchanges can be conducted over a packet-switched network, a circuit-switched network, the Internet, LAN, WAN, VPN, or other type of network. The terms “configured to” and “programmed to” in the context of a processor refer to being programmed by a set of software instructions to perform a function or set of functions.

While the inventive subject matter is susceptible of various modification and alternative embodiments, certain illustrated embodiments thereof are shown in the drawings and will be described below in detail. It should be understood, however, that there is no intention to limit the invention to the specific form disclosed, but on the contrary, the invention is to cover all modifications, alternative embodiments, and equivalents falling within the scope of the claims.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

In some embodiments, the numbers expressing quantities or ranges, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention can contain certain errors necessarily resulting from the standard deviation found in their respective testing measurements. Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified, thus fulfilling the written description of all Markush groups used in the appended claims.

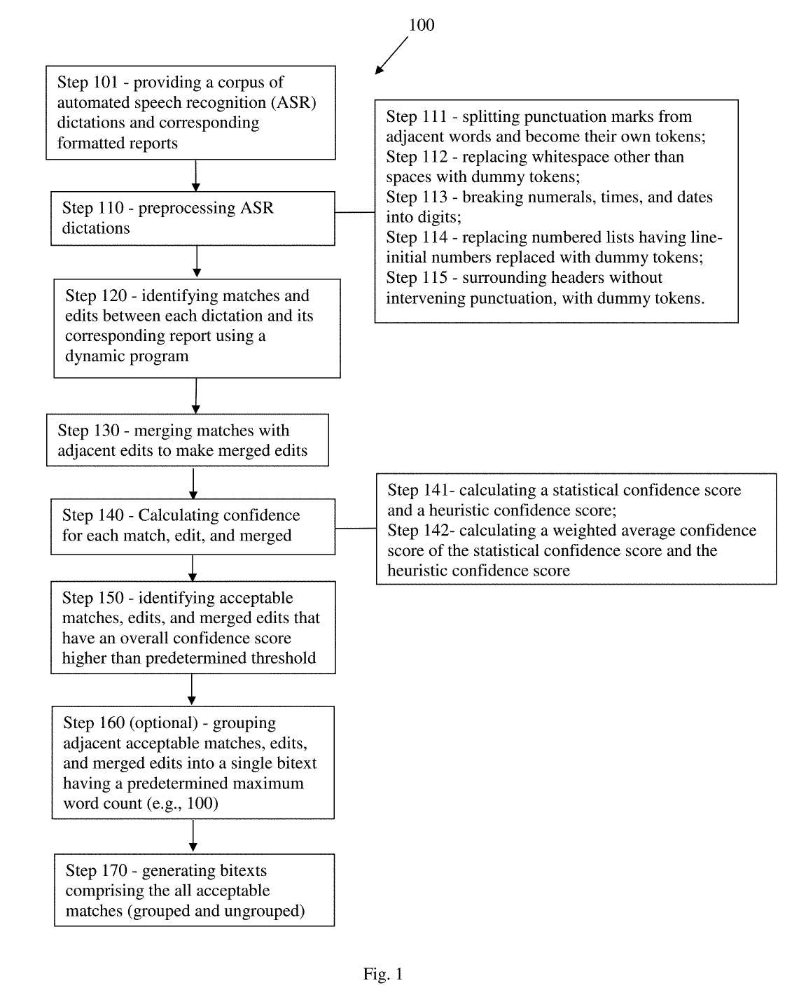

FIG. 1 is a flowchart depicting contemplated steps in preferred methods of generating bitexts for training a SMT system. In Step 101, a corpus comprising automated speech recognition (ASR) dictations and formatted reports is obtained. The dictations are generated by an ASR system. Formatted reports are manually generated by trained medical transcriptionists in the course of providing medical care. In preferred embodiments, each of the formatted reports corresponds to only one automated speech recognition dictation. However, it is contemplated that a formatted report can correspond to several automated speech recognition dictations, and an automated speech recognition dictation can correspond to several formatted reports. As used herein, “correspond” means that the dictation was originally relied upon by a medical transcriptionist to write the formatted report. Preferably, actual clinical notes are used. It is contemplated that reports and dictations can be obtained from a variety of specialties at hospitals.

SMT requires sentence-aligned data, or bitexts: parallel pairs of translational equivalent sentences in source and target languages. The source language is the output from a speech recognition system, usually unformatted text transcripts (i.e., hypotheses), although formatting elements can be represented as words. The target language (output of the machine translation postprocessor) is a fully formatted report, or at least formatted texts representing formatting elements as words that can be easily converted into the final text of a final clinical report. Hypotheses and reports cannot be naïvely used as translational equivalents because there are too many discontinuities between the two. For example: the header and footer of a report often have very different spoken forms in the dictation, or none at all; errors and corrections spoken in the dictation (“scratch that,” e.g.) are not present in the report; and reports may contain boilerplate sections that correspond to only a few words in the transcript. (Additionally, many reports are too long to reasonably use for SMT at all.) In short, the SMT system will fail to learn accurate translations without better alignments between source and target.

Ideal SMT training data will be parallel source (ASR hypothesis) and target (report) text that contains the types of systematic differences that need to be learned, and later applied when the system is put into production and asked to decode arbitrary inputs. In preferred embodiments, input-output training pairs are created as lengthy as possible while still being representative of these differences. For example, the report text
. . . rem onset from sleep onset was 1_{—} 4_{—} 3 minutes. <para> HEADER_START sleep architecture is as defined HEADER_END stage i 1_{—} 1% . . .
   and the dictation text
. . . r_e_m onset from sleep onset was hundred and forty three minutes next line sleep architecture is as defined colon stage one eleven percent . . .
   will ultimately be considered a single input-output pair for training SMT, even though there are phrasal substitutions between them (as shown in bold); the SMT system will learn to make substitutions such as these. Note that, as mentioned above, numerals and formatting elements in this example report text are represented as words.

Step 110—preprocessing ASR dictations. All reports are subjected to text preprocessing to better enable the translation system to reproduce punctuation and other formatting elements as well as to combat problems of sparsity for numerals. Steps include:
Step 111—Punctuation marks are split from adjacent words and become their own tokens.
Step 112—Whitespace other than spaces is replaced with dummy tokens, with unique tokens for newlines, paragraphs (2 or more newlines), and tabs.
Step 113—Numerals, times, and dates are broken into their digits, with ‘_’ signaling continuation: for example, ‘2016’ becomes four tokens, ‘2_’, ‘0_’, ‘1_’, ‘6’. Times and dates have dummy tokens for the separators ‘/’ and ‘:’.
Step 114—Numbered lists have line-initial numbers replaced with dummy tokens. The first item in a numbered list has one token (‘NUM_LIST_1’), and all subsequent numbers have another (‘NUM_LIST_8’). Analogous dummy tokens also exist for lettered lists.
Step 115—Headers, defined as between 1 and 6 words on a line without intervening punctuation, are surrounded by ‘HEADER_START’ and ‘HEADER_END’ dummy tokens.

Step 120—Dynamic alignment. This step uses dynamic programming (DP) to identify matches and edits of one or more words between each dictation and its corresponding report. Alignments between source and target texts are obtained using DP. The algorithm used is similar to a basic DP program used, for example, to calculate Levenshtein distance between two strings, but with some key modifications that promote longer matches and substitutions as well as matches (summarized in table below).

The differences between the basic DP can be summarized as follows:

| Basic DP | DP in the current invention |
|---|---|
| Matches between source and target rely on | Non-exact matches are possible on second |
| exact string match between the two words and | and future runs of the algorithm (see below |
| always incur a cost of 0. | for details); these matches will incur some |
| | small cost. |
| Substitutions can only be between single words. | Phrases of more than one word can be |
| | substituted for other phrases. |
| All edits (insertions, deletions, and substitutions) | Edits that extend a previous edit |
| incur a fixed cost of 1. | (lengthening a phrase of deleted words, |
| | e.g.) incur a smaller cost (2) than starting |
| | a new edit (4 for insert/delete, 5 for |
| | substitute). |

For example:
Hypothesis: patient was last seen on july five two thousand seventeen with complaints of
Report: patient was last seen on 7 DATE_SEP 5 DATE_SEP 2 _{—}0_{—} 1_{—} 7 with complaints of

The DP will consider the bold phrase to be a single long substitution, and the non-bold text on either side to be matches. Under a “vanilla” (single-point edits only) DP, 5 substitutions and an additional 3 deletions to go from the text on the right to the text on the left would be needed. But this would be uninformative because it does not capture the fact that the bolded phrases indicate the same thing; furthermore, it would be arbitrary which words are considered subs versus deletions (of the 8 words you need to deal with on the right side, 3 of them must end up being deletions because there is no word on the left to substitute them for). Edits that extend a previous edit . . . incur a smaller cost (2) than starting a new edit (4 for insert/delete, 5 for substitute). So the edit here “costs” 5 for the first edit plus 2*7 for each additional substitute/delete added to the phrasal substitution, for 19 total; considering this 5 subs+3 deletes would be a total cost of 37, so the DP goes with the cheaper alternative (19).

In certain conditions, it is possible for two words to be considered a match even if they are not a perfect string match. This can only occur if the SMT system has already been trained at least once, as this training will produce word replacement statistics as a by-product. (Note that this training refers to a much later stage, as described below in Step 210.) In preferred embodiments, if the probability of a target word replacing a source word is determined using this method to be at least 0.8, then the two words will be considered a match by DP and will incur a cost of 1 minus this probability. This may be the case for numerals and other predictable elements: the word ‘six’ in a dictation is almost always replaced with the digit ‘6’ in the report, for example. If these word replacement statistics are not available, then all non-perfect matches will be considered substitutions.

Step 130—Merging adjacent matches and edits. Before calculating the confidence of all matches and edits, some matches and edits are merged together to form a merged edit according to a heuristic algorithm. In preferred embodiments, every single-word match will be merged with a preceding edit of three or fewer words and with as many consecutive following edits of three or fewer words as possible; the resulting span will be considered a substitution.

The goal of merging is to produce longer ranges that will have higher confidence. An example situation in which this would be useful is when two short substitutions surround an exact match of one word: this entire range will be scored with a higher confidence if considered as one long substitution, whereas either or both of the two short substitutions may fail to reach the confidence threshold on their own.

Step 140—Calculating confidence. For each match or edit, a confidence score between 0 and 1 is calculated using a combination of a heuristic and statistical method. Scores from each method are averaged, with much higher weight given to the statistical score in preferred embodiments. For example, in one preferred embodiment, the statistical score is given 80 percent weight, while the heuristic is given 20 percent weight. In another preferred embodiment, the statistical score is given 95 percent weight, while the heuristic is given 5 percent weight. Similar to the probabilistic match used in DP, if the SMT model has not been trained at least once, the statistical method cannot be used, and all weight is given to the heuristic.

The statistical method of calculating confidence relies on creating word-to-word alignments for a phrase by finding the pairing with the highest conditional probability of target word given source word for each word in the target. The final confidence score is the probability averaged over all words. As with the DP, these single-word probabilities are estimated from the counts of word-to-word alignments generated in the initial phase of SMT training.

For the heuristic method, edits are given confidence scores based on their length, type of change, and the words present. Confidence scores are higher for longer substitutions and for shorter inserts and deletes; scores are also higher if the preceding and following edits are long. All matches between source and target receive a perfect confidence score of 1. This method is designed to encourage longer input-output pairs while still retaining high confidence that these pairs are appropriately matched. Consider, for example, the matching report/hypothesis segment:
Report: . . . 6_{—} 8_{—} 6_ <nl> HEADER_START medical record number 0_{—} 8_{—} 1_{—} . . .
Hypothesis: . . . six eight five medical record number is zero eight one . . .
   This pairing consists of multiple matches and edits:

| MATCH | DELETION | MATCH | INSERTION | MATCH |
|---|---|---|---|---|
| . . . 6_ 8_ 5_ | <nl> HEADER_START | medical record number | — | 0_ 8_ 1_ . . . |
| . . . six eight five | — | medical record number | is | zero eight one . . . |

The substitution of letters with numbers is still considered as a match because the statistics of correspondence between spoken and written digits are so clear. The alignments done during automatically during SMT training will very quickly find that 6_{—} pairs with six, for instance, so future runs of DP will consider 6_{—} and six to be a match.

However, the edits all receive relatively high confidence scores because they are short (only one or two tokens) and because they are surrounded on at least one side by a long match. Thus, this entire pairing will be effectively considered a single high-confidence substitution and will ultimately be used as a single bitext sample for SMT training.

Step 150—identifying acceptable matches, edits, and merged edits that have an overall confidence score higher than a predetermined threshold (i.e., confidence minimum). Confidence minima are set differently for substitutions, inserts and deletes, and matches (all matches pass confidence checks). Inserts/deletes have a higher minimum confidence because these are more likely to be the non-systematic types of edits (add a medications section, delete pleasantries, etc.), so it's undesirable to include them unless it is fairly confident that they are common or systematic edits (judged by heuristics and statistics, as described). In preferred embodiments, the confidence minimum is between 0.01 and 0.2 for substitutions, and between 0.2 and 0.5 for inserts and deletes, inclusive. In especially preferred embodiments, the confidence minimum is between 0.05 and 0.15 for substitutions, and between 0.3 and 0.4 for inserts and deletes, inclusive. Most preferably, confidence minimum for substitutions is 0.1 and 0.37 for inserts and deletes.

Step 160 (optional step)—grouping adjacent acceptable matches, edits, and merged edits into a single bitext. In preferred embodiments, adjacent acceptable matches, edits, and merged edits into a single bitext having a predetermined maximum word count. It is contemplated that an iterative algorithm can be used to traverse all high-confidence edits and matches and builds windows of words (“sentences” of training data), preferably between 10 and 1000 words. In especially preferred embodiments, the maximum is 100 words in length. Contemplated overlap between windows can vary between 10% and 90%. In preferred embodiments, the overlap between windows is between 30% and 80%. In especially preferred embodiments, these windows will overlap by up to two thirds the width of the window (i.e., 67 words each).

In the following example, a single long utterance is split into four shorter, partially overlapping ones:

Windows will be cut short if there are edits within them that were scored with low confidence in the previous step, or if there is an edit spanning the 100-word point. (Whenever there is a long match that could be added to a window in progress but is too long, the match is broken in the middle so that the window is exactly 100 words in length; for edits, it is not possible to break in the middle without knowing exact word alignments.)

Preferably, whenever there is an exact string match between words or phrases in source and target, that match is added to the training data as its own “sentence” to help bias the system towards keeping these words and phrases as they appear in the source. Because the SMT system is not actually translating between two different languages, it is safer for the system to simply reproduce inputs that it does not know how to translate than to translate them into incorrect words that were never present.

Step 170—generating bitexts. Bitexts are generated by outputting grouped adjacent acceptable matches and edits, and the ungrouped acceptable matches and edits.

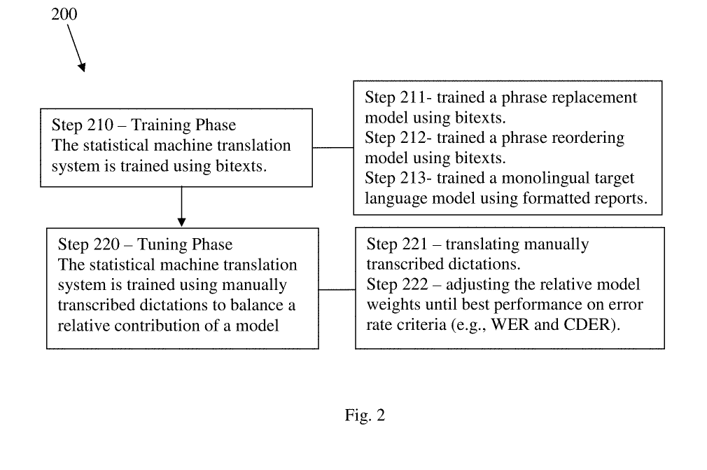

FIG. 2 is a flowchart depicting contemplated steps in preferred methods of training a SMT system. In Step 210 Training Phase, the SMT system is trained using bitexts. The translation engine of the system is a phrase-based SMT system. (One popular open-source implementation of such a system is Moses. [See Koehn, P., Hoang, H., Birch, A., CallisonBurch, C., Federico, M., Bertoldi, N., . . . & Dyer, C. (2007, June). Moses: Open source toolkit for statistical machine translation. In Proceedings of the 45th annual meeting of the ACL on interactive poster and demonstration sessions (pp. 177-180), Association for Computational Linguistics.] Training consists of several steps: learning word-to-word alignments between source and target, learning phrase reordering (“distortion”) statistics, learning conditional n-gram probabilities for the target language, and finally tuning the MT model to balance the relative contributions of these subsidiary models. For the monolingual language model, a 6-gram model is trained with typical interpolation and backoff parameters using the open-source KenLM toolkit.

Word-to-word alignments are the first steps of SMT training and are done using an open-source tool (Giza++). (“Sentence-to-sentence alignments”=bitexts). The initial step of SMT training will produce word-to-word alignments (from sentence-to-sentence alignments), which can be counted to estimate probabilities of one word in the source being replaced by any other word in the target. The translation model relies on word-to-word alignments, which are learned in a standard fashion using the technique of expectation maximization; Och and Ney [see Franz J. Och and Hermann Ney. 2003. A systematic comparison of various statistical alignment models. Computational Linguistics, 29(1):19-51.)] offer an explanation of this method specifically for MT. Subject to these alignments, parallel phrases between source and target of up to seven words in length were extracted. Every unique pair of input-output phrases was kept in a counts table, and these statistics were used to estimate the conditional probability of any known source language phrase being translated into any known target language phrase. During decoding, the log-likelihood of any hypothesis (h), given an input x, under consideration is maximized ; in a general form, this is expressed as a sum of weighted log-probabilities:

P(h|x)=w1*P1(h|x)+w2*P2(h|x)+. . . +wn*Pn(h|x)

where w1, w2, wn are the weights optimized during tuning, and P1, P2, Pn are the probabilities assigned from individual models such as the language model, phrase substitution model, and reordering model, as well as other constraints such as a penalty for hypotheses that are too long.

Step 220—Tuning Phase. The SMT system is trained using manually transcribed dictations to balance a relative contribution of a model. To determine the relative contribution of the phrase, distortion, and language models in computing likelihoods of translation options at decoding time, tuning is performed by using minimum error rate training (Och, 2003): translate all text in a held-out tuning set (Step 211), iteratively adjusting the weights of each contributing model until convergence on an error metric (Step 222).

In departure from common practices in SMT, tuning of parameters is performed to optimize scores on word error rate (WER) and CDER (See Gregor Leusch, Nicola Ueffing, and Hermann Ney. 2006. Cder: Efficient mt evaluation using block movements. In Proc. of the 11th Conference of the European Chapter of the ACL, pages 241-248,Trento, Italy. ACL.), but not on BLEU, the de facto standard metric in MT, as BLEU is more relevant to translation between two different languages than to the problem discussed here. CDER is included, which assesses only a single penalty for “block” movements, to reduce the impact on tuning when entire sentences are reordered between the dictation and final letter; note that WER would assess numerous single-word insertion and deletion penalties in such a case.

Superior translation results are obtained when training the phrase model on ASR hypotheses (the same types of inputs that the system in production use expects) but tuning on manual transcriptions of speech, which appear similar to ASR hypotheses but contain far fewer errors. Thus, the inexpensive process of ASR decoding is used to generate the training data from speech and commission manual transcriptions only for the small tuning set.

Decoding and post-editing. Decoding is performed by choosing the most likely sequence of target-language words according to the tuned model. The hypothesis space, which stores all possible outputs during the decoding process, is kept to a computable size using an implementation of beam search. [See Koehn, P. (2004, September). Pharaoh: a beam search decoder for phrase-based SMT models. In Conference of the Association for Machine Translation in the Americas (pp. 115-124). Springer, Berlin, Heidelberg.]

Following decoding, rule-based post-editing is done to generate human-readable output. This editing is designed to perfectly reverse the preprocessing stage: dummy tokens containing ‘_’ are joined to adjacent tokens without spaces; numbered list dummy tags are replaced with numbers starting from 1 (or ‘a’ for lettered lists), with the count resetting at each paragraph; and other dummy tokens are converted back into their original forms.

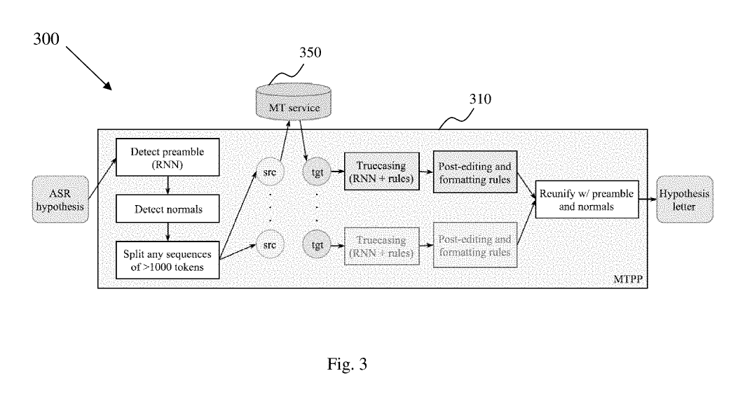

In FIG. 3, the machine translation postprocessor (MTPP) 310 is a system for automated formatting of medical dictations. The MTPP comprises at least three major components: the creation of bitext training data from matched medical dictations and typed reports, the training and tuning of a phrase-based SMT system, and the application of this system as a streaming service for automated formatting of medical dictation transcripts.

The formatting accomplished by a statistical machine translation (SMT) system 350. SMT (or MT) system can be integrated into a system for automated formatting of medical dictations, machine translation postprocessor (MTPP). MTPP uses statistical machine translation (SMT) in conjunction with novel methods (e.g., dynamic phrase-to-phrase alignment and a hybrid heuristics- and statistics-based procedure to identify high-confidence regions) to generate parallel training data from speech transcripts and manually formatted reports. The SMT system is trained with the parallel training data.

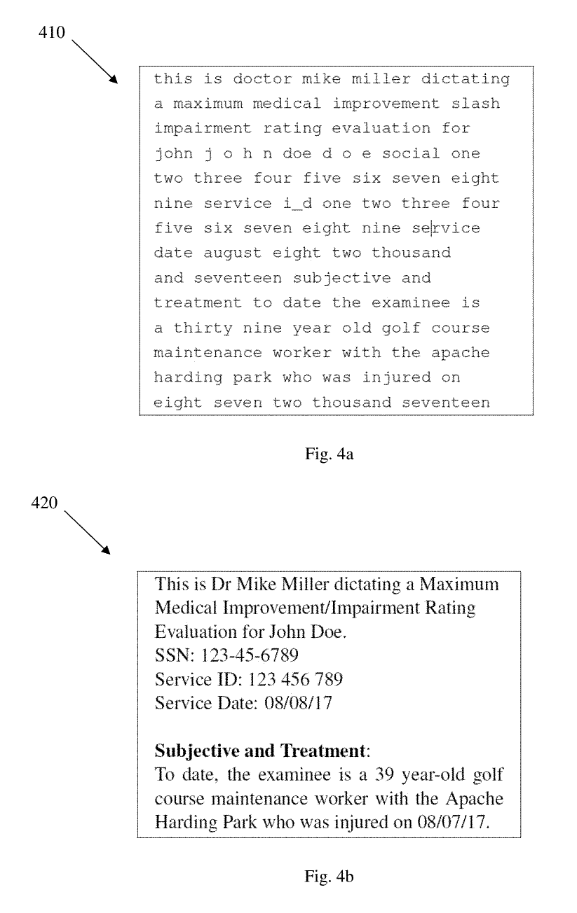

FIG. 4a is a raw output 410 of a medical speech recognizer, without formatting. The raw output 410 is the input of a MTPP. FIG. 4b is an output 420 of a MTPP, with correct formatting. The output 420 of the MTPP is a fully formatted report, or at least formatted texts that can be easily converted into the final text of a final clinical report.

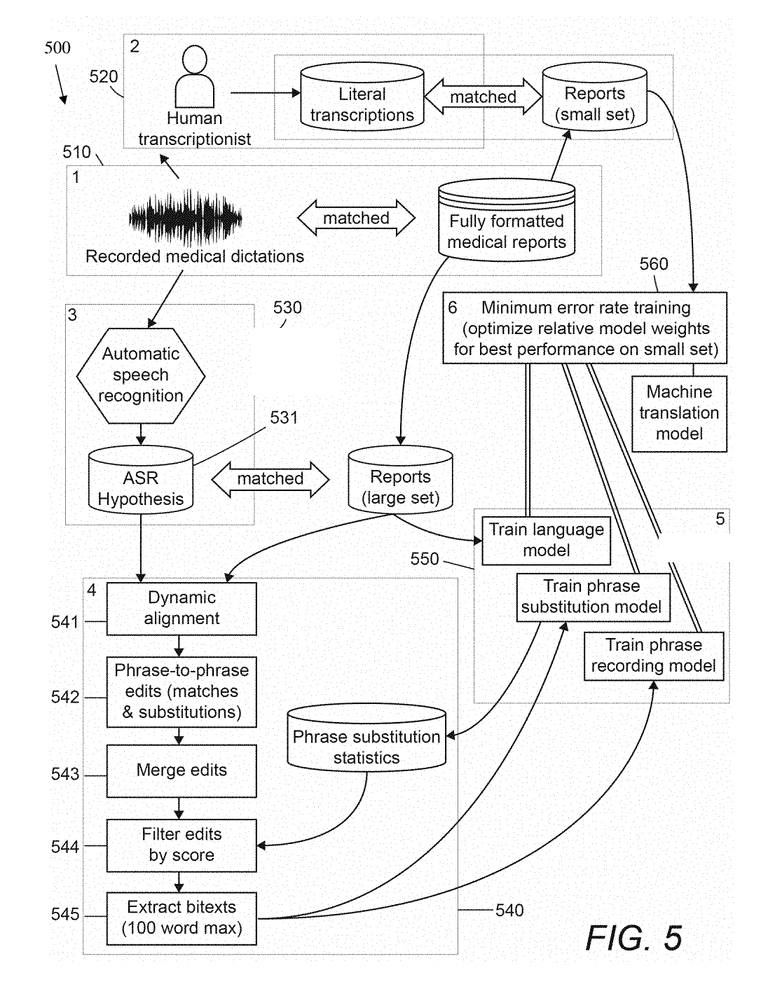

FIG. 5 is an overall schematic of preferred methods 500 of generating bitexts for training a SMT system and training the SMT system. In Step 510, Matched sets of audio and fully formatted medical reports (i.e., one dictation per report) are obtained. In step 520, small set is sent for manual transcription. In step 530, a large set is sent through speech recognition. In step 540, the large set is then processed through a bitext generation system. Dynamic programming produces phrase-to-phrase (between ASR hypothesis and report); these edits are merged where appropriate, then filtered based on a score that is assigned by a mix of statistics and heuristics (and the statistics are updated with every run, as shown in the figure); finally, bitexts (the actual currency of MT training) are extracted according to a sliding 100-word window. In Step 550, the bitexts are used for training phrase substitution and reordering models. The original reports are used to train a monolingual (i.e., reports-only) language model. In step 560, the relative contributions of all of these models on the final translation output are optimized. The small set of manually transcribed dictations and reports to do this: iteratively translate the whole small set and adjust the relative model weights until convergence (best performance).

To create bitexts, the system finds alignments between ASR hypotheses 531 and reports and considers all regions of those alignments that are the same (“matches”) and different (“edits,” comprising insertions, deletions, and substitutions). The initial stage of finding alignments (dynamic alignment, step 541) uses dynamic programming (DP) similar to that used to calculate Levenshtein distance. In Step 542, The DP identifies matches and edits (e.g., insertions, deletions, or substitutions) between words and phrases in source and target. In Step 543, matches are merged with adjacent edits. In Step 544, all matches and edits are then assigned a confidence score based on the length and type of edit. In Step 545, an iterative algorithm selects sequences of up to preferably 100 words of parallel data from source and target languages, using the confidence metric to exclude ranges that are unlikely to be true matches. The resulting sequences are then used as bitext training data for an SMT system.

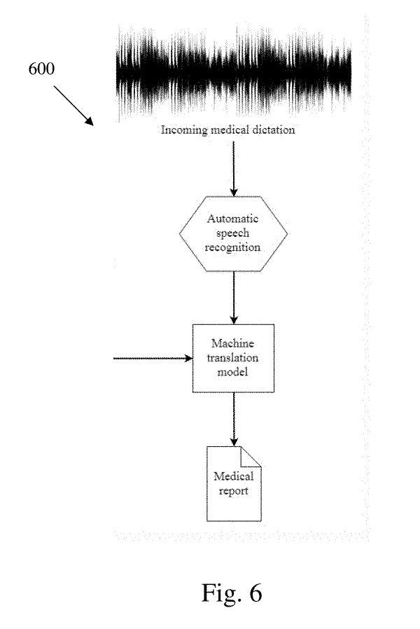

FIG. 6 shows a method 600 in which the SMT model in FIG. 5 is deployed in a production setting, where incoming ASR hypotheses are translated into reports intended for manual correction and entry into an EMR system. It is contemplated that some or all of the contemplated other steps can be performed in real time or near real time. “Real-time” means input data is processed within milliseconds so that it is available virtually immediately as feedback. “Near real-time” means input data is processed within several seconds.

### Exemplary Embodiment

In this exemplary embodiment, actual clinical notes are used. Reports and dictations from a variety of specialties at two different US hospitals were considered. As required under HIPAA, a Business Associate Agreement with the Covered Entity that supplied the data.

A set of 9,875 reports was identified to be available for manual transcriptions and ASR hypotheses. This set was split into four smaller sets. The training set was used to generate source-to-target alignments and build the phrase and distortion models, as well as to train the monolingual language model. (The latter was trained on additional text as well, for a total of 23,754 reports and 14,208,546 words.) The tuning set was used for tuning the relative contribution of the various models for MT. The development set was used for evaluation along the way. Finally, a blind test set was set aside for testing purposes.

For both training and tuning transcripts, hypotheses, or a combination of the two (nine separate conditions) were used. Hypotheses would seem more relevant to the desired task; however, they are a noisier source of data than transcriptions, and it was not guaranteed that the needed correspondences could be learned through the noise.

Although the data set contains dictations and their corresponding reports, these do not represent true bitexts of the type that are typically used for MT, for several reasons: boilerplate language or metadata may be added to the letter; whole sections may be reordered, or even inserted from prior notes in the patient's history; pleasantries, discontinuities, or corrections by the speaker will be omitted. Furthermore, notes can be thousands of words in length, and it is not practical to learn alignments from such long “sentences” given computational constraints.

To solve these problems, a method was developed to extract matching stretches of up to 100 words from the source and target, which can then be used as training samples. The procedure entails five major steps.

Step 1—Text preprocessing. Punctuation, newlines, tabs, headings, and list items are separated from adjacent tokens and converted into dummy tokens. All digits become their own tokens.

Step 2—Dynamic alignment. All matches and edits between source and target are determined using dynamic programming, similar to that used for Levenshtein distance but with key differences: matches are permitted between non-exact string matches if they are determined, in a previous run of the algorithm, to be possible substitutions; edits can be longer than one token; and extending an edit incurs a lesser penalty than beginning a new edit.

Step 3—Merging edits. Short substitutions are merged together if there is an intervening single-word match between them, and the entire range is considered a substitution. The resulting edits allow for longer stretches of parallel sentence data.

Step 4—Calculating confidence. For every edit, a score is calculated based on a mix of statistics (calculated from a prior run of the dynamic program), and a heuristic that assigns higher scores to longer substitutions, to shorter insertions or deletions, and to edits that are adjacent to other long edits.

Step 5—Extracting sentences. An iterative algorithm traverses all edits and matches from left to right, building a parallel source-target “sentence” as it goes. A sentence ends when an edit of too low confidence is reached, or once it exceeds 100 words. In the latter case, the next sentence will start one-third of the way through the previous one, so sentences may overlap by up to 67 tokens.

Each extracted sentence becomes a training sample. Any single-word string matches are also written as training samples—because this is not a typical MT problem in that the source and target “languages” are both English, it is desirable to bias the system towards simply regurgitating input words it does not know how to translate. From 8,775 reports, this method generates many training samples: 4,402,612 for transcripts, 4,385,545 for hypotheses, and 8,788,157 for the combined set. See Table 1.

TABLE 1
Statistics of the data sets used for training, tuning, development, and
test.

| Set | # Reports | # Words |
|---|---|---|
| Training | 8,775 | 4,785,986 (Rep.) |
| | | 5,363,580 (Tra.) |
| | | 5,681,630 (Hyp.) |
| Tuning | 500 | 276,551 (Rep.) |
| | | 311,538 (Tra.) |
| | | 305,672 (Hyp.) |
| Development | 300 | 187,472 (Rep.) |
| | | 211,740 (Tra.) |
| | | 209,587 (Hyp.) |
| Test | 300 | 177,756 (Rep.) |
| | | 198,722 (Tra.) |
| | | 196,198 (Hyp.) |

For the translation model, typical statistical MT techniques are employed. Optimal word-to-word alignments between source and target were learned using expectation maximization. Subject to these alignments, parallel phrases of up to seven words in length were extracted. For the monolingual language model, a 6-gram model was trained with typical interpolation and backoff parameters.

The MT training stage yields a phrase substitution model and a distortion model. To determine the relative contribution of the phrase, distortion, and language models in computing translation option likelihoods, tuning was performed by minimum error rate training: translate all text in a held-out tuning set, iteratively adjusting the weights of each contributing model until convergence on an error metric. Interpolation of word error rate (WER) and CDER (which is designed for assessing MT quality on the sentence level) were used, which only assesses a single penalty for “block” movements. CDER was included to reduce the impact on tuning when entire sentences are reordered between the dictation and final letter; note that WER would assess numerous single-word insertion and deletion penalties in such a case.

The MT system be integrated into a complete software product, which we refer to as the machine translation postprocessor (MTPP), responsible for all stages of transformation between the raw ASR hypothesis and the generated report. Although the bulk of the decisions made during this process are handled by MT, the MTPP is responsible for selecting and preparing inputs for MT and transforming outputs into human-readable form. FIG. 1 is a schematic of an embodiment of a machine translation postprocessor (MTPP) 200.

As used herein, “daemon” means a computer program that runs as a background process, rather than being under the direct control of an interactive user. “Preamble” means spoken metadata that is often not present in the final report. “Levenshtein distance” is a string metric for measuring the difference between two sequences and is defined by between two words as the minimum number of single-character edits (e.g., insertions, deletions or substitutions) required to change one word into the other.

At the first stage, the preamble and any commands to insert a template are isolated and not sent to MT. Of the pieces that are subject to MT, any that exceed 1,000 tokens are split. The resulting chunks are sent to an MT daemon which has models pre-loaded into memory and can perform multiple translations in parallel. To each translated chunk, truecasing and post-editing is applied, including the steps of joining digits, formatting headings, counting and labeling entries of numbered lists, etc. Finally, all chunks are unified and put into the correct order.

The preamble detector is based on a two-class recurrent neural network (RNN) classifier with pre-trained word embeddings and long short-term memory (LSTM) units, which tags tokens as either in- or out-of-preamble, then finds the split boundary according to a heuristic. The RNN truecaser has a similar architecture but predicts one of three classes for each token—all lowercase, first letter uppercase, or all uppercase—through one layer of softmax output shared across all time frames. This classifier was trained on automatically generated data from 15,635 reports. Truecasing is also supported through rule-based decisions as well as lists of truecased forms compiled from ontologies and prior reports, which include non-initial capitalizations (‘pH’, e.g.).

The performance of all models was assessed in two text domains: the MT target domain, and the post-processor error rate (PER) domain. In MT target domain, numerals are split into individual digits, headers are surrounded by dummy tokens, and case is ignored. The PER domain is used to estimate the manual effort required to correct errors in the hypothesis report. PER can only be calculated from final outputs of a post-processor, and thus depends upon the integration with a MTPP.

PER is calculated similarly to WER except that it considers punctuation, newlines, and tabs as separate tokens, and it excludes any detected preamble from consideration (keeping the preamble leads to a slight increase in PER globally). PER is an especially harsh metric in real-world use, as it penalizes ASR errors, post-processing errors, and any other source of distance between the post-processor's output and the final letter following multiple rounds of manual review.

In the MT target domain, three standard measures of MT performance are presented: WER, CDER, and BLEU (baseline line). Results for all possible configurations of training and tuning data sources are given in Table 2.

TABLE 2
Evaluation of test set on different training and tuning configurations
with BLEU, WER, and CDER.

| | Train | | | |
|---|---|---|---|---|
| Tune | Hyp. | Tra. | Hyp. + Tra. | Metric |
| Hyp. | 0.742 | 0.746 | 0.741 | BLEU |
| | 0.266 | 0.277 | 0.262 | WER |
| | 0.170 | 0.171 | 0.170 | CDER |
| Tra. | 0.754 | 0.745 | 0.747 | BLEU |
| | 0.559 | 0.276 | 0.258 | WER |
| | 0.164 | 0.171 | 0.167 | CDER |
| Hyp. + Tra. | 0.751 | 0.721 | 0.748 | BLEU |
| | 0.273 | 0.317 | 0.262 | WER |
| | 0.166 | 0.167 | 0.166 | CDER |

Note that these results are on a filtered test set: only source texts of 1,000 tokens or fewer were used (190 out of 300 in the test set), as this was found to be a point beyond which decoding slowed considerably. Note that all BLEU are well above 0.7; these may appear to be exceptionally high scores, but note that the task here is easier than a “standard” translation task—to give some idea of a baseline, comparing the totally untranslated dictations in the test set to their matching reports yields a BLEU of 0.318 (as well as WER 0.514, CDER 0.483), which would be quite impossible in a case of translating between two different languages.

For the realistic evaluation of the complete system, we present PER measurements on final outputs of the MTPP in Table 3. Because the MTPP contains logic for breaking up the translation task across longer notes, no filtering is necessary and all 300 notes in the test set can be used. We must emphasize that these results cannot be compared with any quantities in Table 2, as they are measured in different domains entirely.

TABLE 3
Evaluation of the test set on different training and tuning
configurations in terms of PER.

| | Train | | |
|---|---|---|---|
| Tune | Hyp. | Tra. | Hyp. + Tra. |
| Hyp. | 0.322 | 0.331 | 0.324 |
| Tra. | 0.324 | 0.338 | 0.321 |
| Hyp. + Tra. | 0.328 | 0.349 | 0.323 |

The comparison of PER between all nine conditions suggests that the best results are achieved on training data that includes ASR hypotheses (test of proportions: χ²=533, p<0.001, when comparing average PER with and without hypotheses in training). This result makes sense because the evaluation task is to translate hypotheses, although we had wondered before if hypotheses were too noisy to constitute good training data. For tuning data, it appears that either hypotheses or transcripts yield good results, but a mixed set is always worse (χ²=44.8, p<0.001, comparing average PER when tuned on the mix to PER when tuned on transcripts).

To quantify the impact of MT on postprocessing accuracy, PER of the source hypotheses were measured both before any postprocessing and after passing through the baseline post-processor. Results are reported in Table 4. Overall, the MTPP results in a significant decrease in PER from the previous post-processor: a relative reduction of 21.9% error rate for hypotheses (−χ²=4102,p<0.001).

TABLE 4
Comparison of PER in several conditions. Results are reported using
ASR hypotheses as input (“In: hyp.”), as in other experiments, as well
as using manual transcriptions as input (“In: tra.”).

| | PER | |
|---|---|---|
| Method | In: hyp. | In: tra. |
| No post-processing | 0.619 | 0.574 |
| Non-MT post-proc. | 0.411 | 0.341 |
| MTPP (best MT model) | 0.321 | 0.271 |

For further context, we also report PER using manual speech transcriptions as input (the rightmost column of Table 4). This is not a realistic use case, but we provide the measurements here to give a sense of the effect ASR errors have on typical PER measurements. The ASR WER of the MT test set was 0.142—much greater than the observed PER difference between hypotheses and transcripts, indicating that many formatting errors in PER occur on the same tokens as ASR errors.

For the MT models that learn from hypotheses, it was conceivable that they could actually learn to correct ASR mistakes by identifying common error patterns and how they are typically corrected in the final letter. To the MT system, there is no essential difference between, say, inserting formatting elements around a section header and replacing an erroneously recognized phrase with the intended phrase from the report; all words, numerals, and structural elements are tokens alike.

Indeed, on multiple occasions, the test set of phrases in MTPP output were more similar to manual transcriptions of these dictations than to the ASR hypotheses that served as input to the MTPP. Refer to the examples in Table 5: each shows a transcript of a segment of speech (first line), the ASR hypothesis on that same segment (second line), and the output of the MTPP when given the ASR hypothesis as input (third line). In each, the MTPP output contains a bolded segment that is closer to the transcription than to the hypothesis. (Although note some incomplete cases, such as “hospitalist was come by and see” in the second example.) None of the transcriptions from the test set were ever seen by any system during training, tuning, or testing (all previous quantitative results used ASR hypotheses, not manual transcriptions, as the source language).

Referring to Table 5: In each set of three lines, the first is the manual speech transcript, the second is the ASR hypothesis of the same audio, and the third is the output of the MTPP given the ASR hypothesis. Bolded text shows where the MTPP has generated output closer to the actual speech than to its input. Note, for the third example, that the abbreviation ‘a.c.’ (ante cibum) indicates to take the medication before meals, and ‘h.s.’ (hora somni) at bedtime.

TABLE 5
Examples where the MTPP has “corrected” ASR errors.

| | |
|---|---|
| Tra. | . . . her mother was here and had them gave her ibuprofen as |
| | soon as she started . . . |
| Hyp. | . . . her mother was here and have him give her an i_v profile |
| | missing she started . . . |
| MTPP | . . . her mother was here and gave her ibuprofen missing, she |
| | started . . . |
| Tra. | in the meantime comma i will have hospitalist come by and |
| | see the patient . . . |
| Hyp. | in the meantime comma i will have our hospital was combine |
| | to the patient . . . |
| MTPP | In the meantime, I will have hospitalist was come by and see |
| | the patient . . . |
| Tra. | carafate one gram a_c and h_s venlafaxine e_r seventy five |
| | milligrams a day |
| Hyp. | carafate one gram a_c_n_h_s meloxicam m e r seventy five |
| | milligrams a day |
| MTPP | 6. Carafate 1 g before meals and at bedtime. / 7. Venlafaxine |
| | ER 75 mg a day. |

Using MT for the post-processing task has numerous advantages over other approaches, including achieving high level of accuracy, even roundly outperforming a system containing numerous hand-designed rules and deep learning approaches that were trained on large amounts of annotated data.

Additionally, MT is a better solution for an adaptable and improvable system. The core of the system can be adapted to other dialects of English or even other languages by retraining the models. Even in the simplest use case, however, retraining can be periodically undertaken to improve performance on current data, accounting for possible changes over time in dictation or report writing style, as well as any ongoing development of the associated speech recognizer.

Another advantage is in the cost of maintaining the system. Although MT training has relatively high compute and memory requirements, there is very little cost in human time to retrain new models. Although use of some transcriptions was required for best results, the exemplary embodiment demonstrates that the entire process can be reproduced fruitfully without them (and may even be subject to less unpredictability). To continuously improve a rule-based system, direct human intervention is required to write and validate new rules. For any supervised machine learning modules of a post-processor, human annotators may also be required.

The exemplary embodiment is a complete and validated medical ASR post-processing system that relies on MT, as well as the novel processing methods required to ensure that MT is a viable approach for clinical dictations. The exemplary embodiment has multiple significant advantages compared to traditional rule-based approaches, and even other machine learning-based ones—not only does the MT design result in substantially reduced formatting errors, achieved in part by its ability to correct errors made by the speech recognizer in the first place, but it can also be retrained and improved fully automatically, without the need for costly manual adjustments.

The exemplary embodiment shows that the SMT system dramatically outperformed an alternative automated formatting system, which relied on a combination of rule-based and machine learning modules. SMT generated superior results to the alternative method: errors between the formatted hypothesis (i.e., the output of the SMT system) and the manually written medical report saw a relative reduction of 22% from the alternative system's error rates. When given the choice between either ASR hypotheses or fully manual literal transcriptions to use as source-language text, best results can be obtained using hypotheses during the training phase but transcriptions during the tuning phase. Thus, the inventive subject matter incorporates a step of manual transcription of a small set of documents for tuning data. Because the SMT system is trained on ASR hypotheses, it learns to identify and reverse common and/or systematic errors made by ASR. (See Table 5 for examples.) SMT handles these substitutions as part of the same phrase substitution model that handles automated formatting steps such as the insertion of punctuation, reformatting of dates, etc.

ASR hypotheses were considered as a good candidate for a training input because the deployment-time inputs would be of this type as well. However, it was uncertain that training on hypotheses would be more beneficial than training on manual transcripts, as the former contain numerous inaccuracies that may have interfered with the model's ability to learn common input-output correspondences. That is, if the errors made during ASR are not systematic or predictable enough, then hypotheses would constitute data much noisier than transcripts without being more informative. As it happens, there is enough systematicity to ASR errors that it is helpful to learn their statistics and common desired replacements.

Surprisingly, the opposite behavior was observed with respect to the tuning set: although hypotheses are more realistic inputs than manual transcripts, tuning on transcripts yielded a model that achieved significantly lower error rates when translating a set of hypotheses. It is conceivable that, as there are so few documents in the tuning set compared to the training set, the misrecognition-related noise statistics of the tuning set may not have been representative of this noise overall, which would have biased the final translation model towards the particular documents in the tuning set at the expense of others. Manual transcriptions will not bias the model towards any pattern of noise, as they are virtually free of errors.

It should be apparent to those skilled in the art that many more modifications besides those already described are possible without departing from the disclosed concepts herein. The disclosed subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps can be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of generating a plurality of bitexts for training a statistical machine translation system, comprising:
providing a corpus comprising (i) a plurality of automated speech recognition dictations and (ii) a plurality of formatted reports, wherein each of the formatted reports corresponds to one of the plurality of automated speech recognition dictations;
preprocessing the plurality of automated speech recognition dictations;
identifying matches and edits of one or more words between each preprocessed dictation and its corresponding report using dynamic programming;
merging one or more matches with one or more adjacent edits to produce one or more merged edits;
calculating a confidence score for each match, edit, and merged edit;
identifying acceptable matches, edits, and merged edits that have an overall confidence score that is higher than a predetermined threshold;
grouping adjacent acceptable matches, edits, and merged edits into a plurality of grouped acceptable matches and edits; and
generating a plurality of bitexts, each having a predetermined maximum number of words, comprising the grouped acceptable matches and edits and ungrouped acceptable matches and edits after grouping.

2. The method of claim 1, wherein the step of preprocessing the plurality of automated speech recognition dictations comprises:
separating a punctuation mark from an adjacent word into a separate token;
replacing a whitespace with a dummy token;
breaking a numeral, time, and date into digit;
replacing a numbered list having line-initial numbers with dummy tokens; and
surrounding a header without intervening punctuation, with a dummy token.

3. The system of claim 1, wherein the step of calculating a confidence score comprises:
calculating a statistical confidence score and a heuristic confidence score for each match, edit, and merged edit; and
calculating a weighted average confidence score of the statistical confidence score and the heuristic confidence score for each match, edit, and merged edit.

4. The system of claim 3, wherein the statistical confidence score is given more weight than the heuristic confidence score.

5. The system of claim 4, wherein the statistical confidence score is given 90% weight and the heuristic confidence score is given 10% weight.

6. The system of claim 1, wherein the plurality of automated speech recognition dictations comprises a plurality of source words and the plurality of formatted reports comprises a plurality of target words, and wherein a target word is a match to a source word if the probability of the target word replacing the source word is at least 0.8, inclusive.

7. The system of claim 1, wherein the step of merging adjacent matches and edits uses a heuristic algorithm.

8. The system of claim 1, wherein the step of grouping adjacent acceptable matches, edits, and merged edits uses an iterative algorithm.

9. The system of claim 1, wherein the predetermined maximum word count is between 50 and 1000 words, inclusive.

10. The system of claim 1, wherein a first bitext overlaps with a second bitext between 30% and 80%.

11. The system of claim 1, wherein the edits comprise a substitution, an insert and a delete, an acceptable substitution having a confidence score of at least 0.05, an acceptable insert having a confidence score of at least 0.3, and an acceptable delete having a confidence score of at least 0.3, inclusive.

12. A method of training a statistical machine translation system having a plurality of models, comprising:
a learning phase, wherein the statistical machine translation system is trained using the plurality of bitexts from claim 1; and
a tuning phase, wherein the statistical machine translation system is trained using a plurality of manually transcribed dictations to balance a relative contribution of a model.

13. The method of claim 12, wherein the statistical machine translation system comprises a phrase replacement model, a phrase reordering model, and a monolingual target language model;
in the learning phase, the phrase replacement model and the phrase reordering model are trained using bitexts from claim 1, and the monolingual target language model is trained using the plurality of formatted reports in claim 1;
in the tuning phase, the statistical machine translation system is trained using a plurality of manually transcribed dictations to balance a relative contribution of the phrase replacement model, the phrase reordering model, and the monolingual target language model.

14. The method of claim 13, wherein the monolingual language model comprises a 6-gram model trained using the opensource KenLM toolkit.

15. The method of claim 12, wherein the statistical machine translation system is trained using an expectation maximization technique.

16. The method of claim 12, wherein, in the tuning phase, training comprises iteratively translating the plurality of manually transcribed dictations and adjusting the relative model weights until convergence.

17. The method of claim 12, wherein, in the tuning phase, the statistical machine translation system is trained to optimize scores on word error rate (WER) and CDER.

18. The method of claim 12, wherein the statistical machine translation system has at least 10% lower error rate after the tuning phase than before.

19. An automated system for formatting texts from medical dictation, comprising:
a processor configured to execute software instructions stored on a non-transitory computer-readable medium, wherein the software instructions are configured to:
a) receive a portion of texts transcribed from words spoken by a medical professional;
b) format the portion of texts using a statistical machine translation system, wherein the statistical machine translation system is trained using the method in claim 12.

20. The automated system for formatting texts in claim 19, wherein the formatted texts are generated in real time or near real time.
